(19) United States
(12) Patent Application Publication
(10) Pub. No.: US 2016/0299359 A1
(43) Pub. Date: Oct. 13, 2016

(54) Interchangeable Eyewear Lenses and Component

(71) Applicants: Yuichi Ogawa, Torrance, CA (US); Huy Dang, Torrance, CA (US); Donn K. Harms, Del Mar, CA (US)

(72) Inventors: Yuichi Ogawa, Torrance, CA (US); Huy Dang, Torrance, CA (US); Donn K. Harms, Del Mar, CA (US)

(21) Appl. No.: 15/036,267

(22) PCT Filed: Nov. 12, 2014
(86) PCT No.: PCT/US14/65326

§ 371 Date: May 12, 2016

Related U.S. Application Data
(60) Provisional application No. 61/903,300, filed on Nov. 12, 2013.

(51) Int. Cl. G02C 9/02; G02C 5/06; G02C 11/02; G02C 1/06

(52) U.S. Cl. CPC G02C 9/02; G02C 1/06; G02C 5/06; G02C 11/02; G02C 2200/08; G02C 2200/20

(57) ABSTRACT

An interchangeable lens system is provided where a first eyewear frame is configured with a snap-in engagement with any one of a plurality of sub-frames having lenses therein. The sub-frames can be engaged through a snap-in engagement with recesses in lens apertures of the first frame or with a slot formed or positioned on the bridge of the first frame. The bridge engaged sub-frame can be rotated out of view through the lens apertures.

### BACKGROUND OF THE INVENTION

1. Field of the Invention

This application is an International Application based on U.S. Provisional Application No. 61/903,300 filed on Nov. 12, 2013.

The present invention relates generally to eyewear. More particularly, the invention relates to a system for removable engagement of lenses and components to a first or user eyewear frame. A lens sub-frame component having a frame member engaged around the periphery of preferably two lenses can be connected to the first eyewear via a snap in removable engagement at a bridge portion or can be configured to snap in and out of the viewing apertures of the main eyewear frame, to provide for easy and quick replacement, or augmentation of one or a plurality of lenses by the user to their eyewear frame. Removable engagement of charms and decorative components is also provided.

2. Prior Art

Eyewear also referred to as eyeglasses or simply glasses, have been worn by individuals for fashion as well as necessity for centuries. Prescription or corrective eyeglasses are typically employed to correct vision deficiencies such as nearsightedness (myopia), farsightedness, astigmatism, and others, and can dramatically improve a user's quality of life by improving vision. Sunglasses are a type of eyewear employing shaded, tinted, or light polarized lenses which provide protection to the user from bright visible light and even ultraviolet light. Other types of eyewear include protective eyewear, sporting eyewear, and others, where each type typically have specific lens properties to provide a certain vision characteristic.

Conventional eyewear generally comprise a frame having viewing apertures adapted to engaged lenses and temple portions typically rotationally engaged to opposite side edges of the frame. The frame can be formed from plastic or metal, while the lenses are conventionally formed from a transparent plastic or glass. In addition, frame-less glasses, unitary lenses, and other eyewear models are also conventionally known in the art.

In the fashion industry in particular, the style of the lens frame can be considered quite a fashion statement. Users may often purchase a plurality of eyeglasses each of different style, as needed for matching with different attire. Many fashionable sunglass frames also include charms or accent pieces engaged on the outside corners of the front of the frame to further increase appeal and provide jewelry of sorts to accompany the user's attire. Further, designer eyewear can be exceptionally expensive due to their connection to a certain trademarked or fashionable brand or individual, and are often sought after by the consumer looking to make a fashion or social statement. As one could imagine, because of this need to match eyewear to clothing, indoor and outdoor venues, and for work purposes, a user's eyewear collection can become quite large and in turn extremely expensive. It would thus, be desirable to be able to adapt expensive and fashionable eyewear, or eyewear a user considers comfortable, for use in multiple places such as at the beach, reading around a pool, or at work reading a computer screen.

As a an impediment of such, most conventional eyewear employ lenses which are securely affixed in their engagement with the frame such that the lenses cannot be removed without substantial skill or force, or without possibly damaging the eyewear lenses or the frame itself. This is unfortunate since a user who has inadvertently scratched or damaged the lenses cannot simply replace the lens in their existing very expensive frame. Further, should a user's venue change or viewing purpose change such as reading in dim light or bright light, the permanent nature of lenses and frames engaged with most eyewear precludes adapting it for multiple uses.

Therefor, if a lens is damaged, or should their vision change, or should their venue or viewing purpose change, a user is typically required to replace the entire eyewear assembly of frame and lenses including the fashion frame which can be quite expensive and time consuming. As such, the user may have to part with a pair of eyewear which they have become accustomed too or are particularly stylish or fashionable, and which are very expensive.

As a result, there exists in prior art many attempts to provide eyewear and eyewear devices which employ means for removable engagement of the lenses to the frame. U.S. Pat. No. 6,074,059 to Glass et. al. is one such example which teaches sunglasses with removable lenses comprising a lens and frame set which is adapted for the easy replacement and/or interchange of the removable lenses from a front side of the frame and is incorporated in its entirety by this reference.

In one embodiment in of the Glass invention, the lens is secured into the frame from the front side by a resiliently compressible barrier which is overcome in order for the lens to be received into and out of the frame. In another embodiment to Glass, the lenses are securable into the frame by friction arising between a resiliently compressible lens gasket that is attached to the periphery of the lens and an interior surface of the cross section of the viewing apertures of the frame.

However, the device to Glass falls short in many aspects. Firstly, Glass teaches that the lenses are replaced individually within their respective viewing apertures of the frame. As such the user must take great care in maintaining continuity between pairs of replaceable lenses and their insertion position, should some lenses have different prescriptive qualities, polarization, or other characteristic which must be employed in complimentary pairs.

A typical user whose is not educated in optics or lens construction may easily mistake one lens type for another, and if employed incorrectly during insertion into the frame, may distort or damage the user's vision or simply render the eyewear inoperable for its corrective purpose. Further, many lenses have asymmetric shapes and as such may be difficult to register in their engagement with the frame without custom configuring of the lens perimeters.

As such, there is a continuing unmet need for an eyewear device and system, providing a means for removable engagement of new or alternate lenses which is easily employed by the user. Such a device should advantageously provide a lens sub frame which engages one or a plurality of lenses therein, and registers the engaged sub frame in proper alignment with a first eyewear frame in a single snap-in engagement. In modes employing at least two lenses, in one mode of snap-in engagement the frame member of the sub-frame should preferably employ an engageable bridge member communicating between the two lenses therefor providing a unitary sub-frame with lenses in correct positions for the eyewear frame. Further, in such a device, the first or main eyewear frame should be configured to removably engage the sub-frame unit in a frictional or snap fit style engagement from a front surface, such that the user can easily and quickly replace a pair of lenses in a registered position on the frame, as needed, but remove them and not have a large unsightly mount viewable.

Still further, such a system should provide for the engagement to charms and decorative items to the first or main eyewear frame of the user to allow for easy and changing decoration thereof.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device and system herein disclosed and described provides a solution to the shortcomings in prior art and achieves the above noted goals through the provision of an eyewear frame engagement system, which provides a means for snap-in removable engagement of a lens sub-frame having one or a plurality of lenses engaged thereon. The user can thus employ the snap-in engagement system to easily augment the lenses of a first pair of eyewear with new or multiple different lenses in sub-framess.

In accordance with a first preferred mode of snap-in engagement, the system herein employs two lenses operatively engaged within a lens sub-frames which includes a frame member which communicates around the peripheral edges of the two lenses. The two surrounded lenses are connected via a bridge member. The communication of the frame member about the peripheral edges of the lens preferably imparts a slight or moderate compressive force onto the lenses engaged with the sub-frames, thereby providing means for securely engaging the lenses thereto. However, other means for engagement of the frame member of the sub-frames to the lenses may be employed and are anticipated. Further, other modes of the device employing a unitary lens eyewear are disclosed later.

The frame member of the sub-frames can be formed of conventional materials such as metal, wire, plastic, or the like. However, it can also be formed from any conventional materials known in the art. For example, the frame member can be formed from lengths of metal wire which bent and configured to provide a seamless engagement around the peripheral edges of the lenses. This can be accomplished by welding or otherwise soldering the ends of the wire communicating around the lens. However, engagement of the frame member to the lens in the sub-frames can be made removable by the employing of a tightening screw, removable fasteners, monofilament line, or other means known in the art.

The main eyewear frame preferably includes a first frame having two viewing apertures and preferably having a bridge portion communicating therebetween. Temples are also provided and are preferably rotatably engaged to the side edges of the first frame as is conventionally known in the art. The viewing apertures include a circumferential contact with the lenses of the main or first frame.

In a first mode of snap-in engagement for a sub-frame, engagement recesses are positioned within the viewing apertures which are configured to removably engage with, or around the exterior of each lens engaged with the sub-frames. The recesses are formed on the front side of the first frame, on the opposite side from the user's face when the frame is worn in an as used position.

If lenses are engaged in the first frame, the user can easily augment those lenses by the snap-in engagement of the sub-frames, to position the lenses of the sub-frames, in front of the lenses in the first frame. If the first frame is configured with no lenses, the user can therefor easily and quickly place and replace the lens sub-frames into the snap in engagement to the main eyewear frame as needed, and can change or replace the lenses therein by a simple subsequent snap in engagement of another sub-frames. In this mode, the bridge member of the sub-frames will simply communicate over the bridge member of the main frame when the lenses are snapped in and engaged therewith.

It is additionally noted that the perimeter or portions thereof of the circumferential contact surface and engagement recesses of the viewing apertures of the front of the main frame can be sized equal to or slightly smaller than the circumferential shape and size of the frame member of the sub-frames. Therefor, the engagement of the sub-frames into the view apertures in the snap-in engagement imparts an additional slight or moderate compressive engagement force around the circumferential peripheral edge of the sub-frames member and the engaged lenses therein providing a means for enhanced engagement thereof.

In this system, the user may have a plurality of different sub-frames with different lenses therein for different purposes such as reading, sunglasses, 3D glasses, etc. and simply insert the sub-frames of choice as needed. Additionally, as noted, the sub-frames and lenses may be employed concurrently with lenses already mounted within the two apertures of the main frame.

In other modes of the device employing a unitary lens type eyewear, the lens sub-frames includes a frame member which communicates around the periphery of a unitary lens. The main frame will include a single viewing aperture having a circumferential recess or other suitable contact surface configured to engaged the unitary lens sub-frames.

Still further, in accordance with at least one other preferred mode of the invention using a snap-in means for removable engagement, the bridge portion of the first frame surface or the main frame, will include a snap-in means for engagement of the bridge member of the sub-frames. This mode of snap in engagement of the sub-frames, employs a recess, cavity, or slot, sized to engage with and around the bridge member of the sub-frames when in the as used position. As such, the snap in engagement of the bridge member of the sub-frames to the bridge member of the first frame, provides means for added securement of the sub-frames to the first frame in the as used position.

Further, because all engagement of the sub-frames are against or to the front surface of the main frame, in plain sight, engagement to the as used position is easily accomplished as is removal.

Additionally, this surface-positioned snap-in engagement of the bridge member of the sub-frames to the bridge member of the first frame can be configured to provide for a rotational engagement, and frictional positioning during such rotation as well. As such, once snapped into a mount, the sub-frames can then be rotated out of alignment with the viewing apertures. However, maintaining the engagement of the bridge portions, thereby providing a ‘flip up’ feature of the sub-frames lenses. This mode is especially useful if the user wishes to add sunglass lenses in front of corrective lenses of the main frame, or sunglass lenses in front of corrective lenses in the main frame, or just using the sub-frame by itself which is one of a kit of sub-frames each with differing lenses in a group. Such a group could include one or a plurality of pairs of lenses engaged to individual sub-frames, where the lenses are corrective, tinted, linear polarized, circular polarized, or the like. In this mode of snap-in engagement, the snap-in mount on the main frame can be formed at manufacture, or can be adhered to the front surface at the bride of the first eyewear frame.

In yet another mode of the device, the first frame of the device may employ pre-engaged lenses within the viewing apertures and may include sub-frames engagement means disposed on the circumferential contact surface of the front of the pre-engaged lenses. For example, the first frame of the eyewear may have prescription lenses engaged thereon and the sub-frames may have tinted or polarized lenses engaged thereon which can be removably engaged within the circumferential recess in the viewing apertures disposed in front of the existing lenses. If rotational engagement is provided on the bridge of the main frame to the sub-frames, the engaged sub-frames and lenses can also be rotated out of the view of the wearer of the main frame and lenses. It is noted however, that the preferred modes of the device can be reversed, such that the disposition of the circumferential contact surface and recess allows the snap in engagement of the sub-frames to be engaged from the rear side of the first frame.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects, features, and advantages of the invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting.

In the drawings:

FIG. 1 shows a perspective view of a first particularly preferred mode of the device depicting the main eyewear frame and sub-frames.

FIG. 1a depicts an adhesively engaged mode of the snap in component, shown in FIGS. 3-5 as permanently formed snap in components.

FIG. 2 shows the mode of the device of FIG. 1 in the as used mode with the sub-frames engaged to the main frame.

FIG. 2a shows a cross sectional view of the engagement of the sub-frames to the main frame as viewed along line AA of FIG. 2.

FIG. 3 shows a detailed view of the another preferred mode of the device and system wherein the main frame includes a snap in means for engagement of the bridge portion of the sub-frames at the bridge portion of the main frame.

FIG. 4 shows the device in the as used mode employing the main frame of FIG. 3. FIG. 5 shows the device of FIG. 3-4 in another as used mode with the sub-frames rotated upon its engagement with the snap in component on the bridge of the main frame in a ‘flipped up’ position.

FIG. 6 shows another preferred mode of the sub-frames of the device employing means for removable engagement with a lens to the sub-frames.

FIG. 7 shows yet another particularly preferred mode of the device employing snap in means for removable engagement of the sub-frames, in front of pre-installed lenses engaged to the main frame.

FIG. 8 shows still yet another preferred mode of the device wherein snap in means for removable engagement of a decorative charm component to the main frame is provided.

FIG. 9a shows a preferred cross sectional view of the charm component receiving cavity to snap into the main frame.

FIG. 9b shows a preferred cross sectional view of the removably engagement charm component.

FIG. 10 shows an example of a preferred mode of a set of removable charm components having star shaped charms.

FIG. 11 shows an example of another preferred mode of a set of removable charm components having circular shaped charms.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

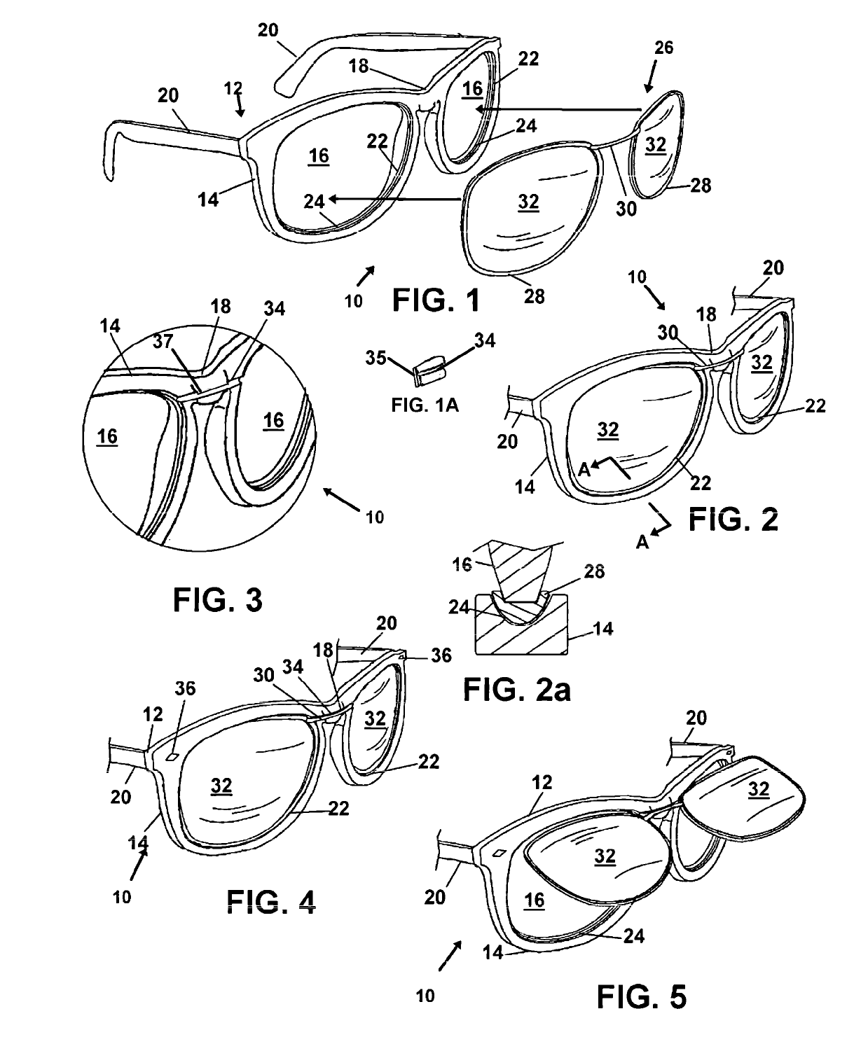

Now referring to drawings in FIGS. 1-11, wherein similar components are identified by like reference numerals, there is seen in FIG. 1 and FIG. 2 views of a first particularly preferred mode of the interchangeable lens eyewear system and device 10 for use with a main eyewear frame 12 having means for snap-in removable engagement, rotational or fixed, of one or a plurality of lens sub-framess 26 having one or preferably a pair of lenses 32 engaged thereon. In accordance with one preferred mode of the invention, the main eyewear frame 12 of the device 10, which may be owned by the user separately, comprises a first frame 14 having two viewing apertures 16 and a bridge portion 18 communicating therebetween. Temples or temple portions 20 are provided and are preferably rotatably engaged at or near the side edges of the first frame 14 as is conventionally known in the art. The means for rotatably engagement of the temples, can be any means known in the art such as a hinge, living hinge, or the like. In addition, removable and rotatable means for engagement of the temple portions 20 which is known in the art may also be employed, and is anticipated.

The lens sub-frames 26 includes frame members 28 which communicate around the peripheral edges of the lenses 32 and a bridge portion 30 engaging the two in a unit. The communication of the lens-surrounding frame members 28 about the peripheral edges of the lenses 32 is preferably configured to impart a slight or moderate compressive engagement force thereby providing means for securely engaging the lenses 32 thereto. However, other means for engagement of the frame members 28 to the lenses 32 may be employed and are anticipated.

The frame members 28 and bridge portion 30 of the sub-frames 26, in all modes can be formed of conventional materials such as metal, wire, plastic, or the like however can be formed from any conventional materials known in the art. For example, the frame members 28 can be formed from lengths of metal wire which bent and configured to provide a seamless engagement around the peripheral edges of the chosen lenses. This can be accomplished by permanently welding or soldering the ends of the wire communicating around the lens.

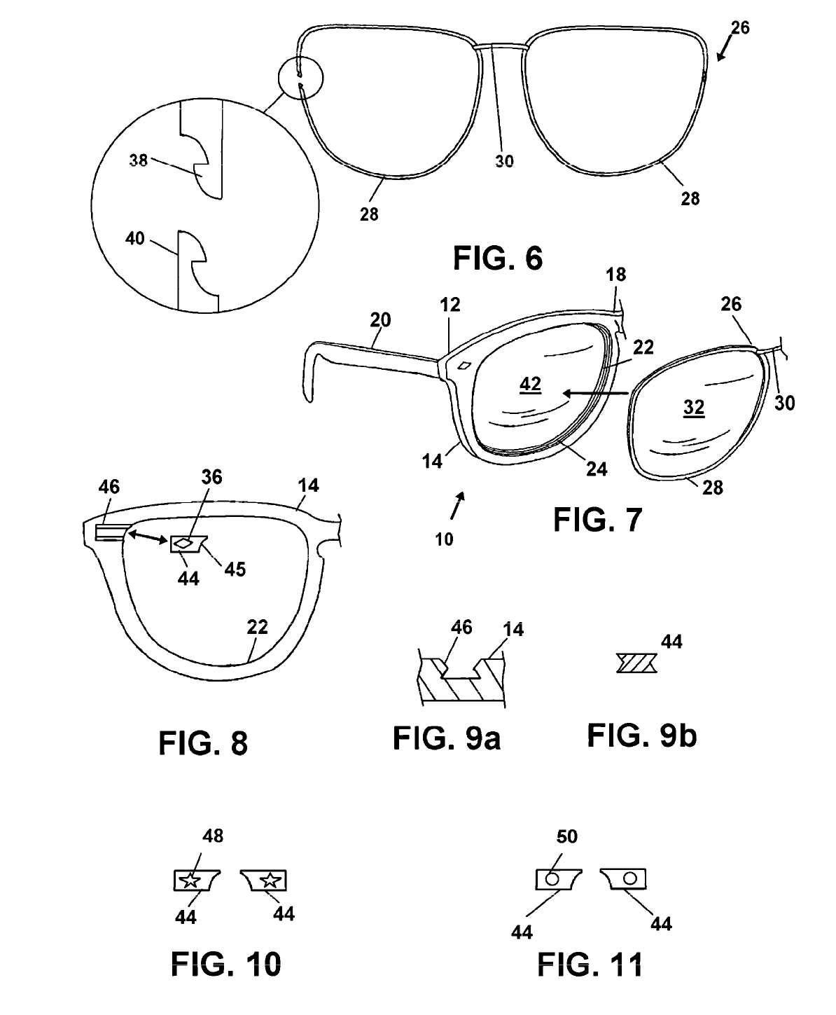

However, engagement of the frame members 28 to the lenses 32 can be a means for removable engagement within the perimeter of the frame members 28, such as through the employment of tightening screw, complimentary fasteners 38 and 40 as shown in FIG. 6, or other suitable means to engage the frame member 28 around a lens 32, to hold it within the frame member 28 such that it can be positioned for use by the user. In FIG. 6, by disengaging the fastener ends 38 and 40 the frame member 28 can be slightly deflected to disengage the lens 32 from the circumferential edge engagement if the lens 32 within the perimeter formed by the frame member 28.

In one mode of snap in removable engagement of the sub-frames 26 to a or first frame 14, the viewing apertures 16 of the first frame 14, include a circumferential surface 22 area in front of the lenses 32, having a circumferential recess 24 (FIG. 2a), providing a means for removable snap in engagement of the perimeter of the frame members 28 of the sub-frames 26, with the first frame 14. This allows the first frame 14 to engage with any appropriately configured sub-frames 26 and the lenses therein. In cases where the main or first frame 14 is a designer or trademark bearing fashion frame, employment of this removable or replaceable sub-frames 26 allows the owner of the expensive first frame 14 to replace damaged lenses if they only have a single sub-frames 26, or to use multiple types of lenses in the same first frame 14 from a kit of sub-framess 26 having pairs of lenses of different optical types such as sunglasses, reading glasses, corrective lenses, polarized lenses etc.

The engaged as-used mode of the sub-frames 26 is shown in FIG. 2 and a cross sectional view shown in FIG. 2a. The user is therefor provided with a means for easily and quickly replacing the lenses 32 to an eyewear frame 12 by simple snap in engagement. In the mode, the bridge member 30 of the sub-frames 26 will be cooperatively curved and shaped to simply communicate over the bridge member 18 of the main frame 12, in the as-used engaged position as shown. There can be a recess formed in the bridge member 30 if desired to further hide the cooperatively curved and shaped bridge member 18 or an insert (not shown) can be provided to cover the slot or recess.

It is additionally noted that the diameter of the circumferential surface 22 of the viewing apertures 16 of the first frame 14 can be sized slightly smaller than the perimeter of the frame members 28 of the sub-frames 26. Therefor the engagement of the sub-frames 26 into the snap in engagement with the view apertures 16 imparts an additional slight or moderate compressive engagement force around the peripheral edge of the frame member 28 and lenses 32 providing a means for enhanced engagement thereof.

In accordance with another preferred mode of the invention, the bridge portion 18 of the first frame 14 includes means for snap in engagement of the bridge member 30 of the sub-frames 26. In FIG. 3, this is shown using a recess, cavity, or slot 34 sized to snap over and removably and rotatably engage the bridge member 30 of the sub-frames 26 in a snap in engagement. As such, the engagement of the bridge member 30 of the sub-frames 26 to the bridge member 18 of the first frame 12 shown in the as used mode in FIG. 4, provides means easy snap in engagement and removable securement of the sub-frames 26 to the first frame 14.

In FIG. 1a is shown, the snap in component of the slot 34 in a removably engageable mode where adhesive 35 such as peel and stick type adhesive is positioned on the rear of a component body having the recess 34 therein. The recess 34 is sized to allow the bridge member 30 to removably snap in and rotatably engage the bridge member 30 of the sub-frames 26. This engageable snap in component can be employed on any frame having a central area between the lense where the adhesive 35 can be engaged to hold the body having the recess 34 therein, and thereby adapt eyeglasses lacking the recess 34 to have one and then employ such with the rotatable sub-frames 26 as described herein.

As in all modes of the device using a recess 34 for a snap in engagement of the bridge member 30, the recess 34 is formed to have an opening 37 slightly smaller than the diameter of the bridge member 30 such that a slight expansion occurs when the bridge member is pressured to snap into engagement through the opening edge. Once positioned within the cavity forming the recess 34, the bridge member 30 cannot dismount since the opening wraps around the bridge member 30 and is smaller in diameter than the bridge member. Removal is by pulling or pressuring the bridge member 30 to expand the opening of the recess 34, to allow it to dismount from the snap in engagement.

Additionally as shown in FIG. 5, a rotational engagement if employed, allows the sub-frames 26 to be rotated out of its engagement with the circumferential recess 23 of the viewing apertures 16 however maintaining the engagement of the bridge portions 18, 30, thereby providing a ‘flip up’ feature of the device 10. The snap in engagement with the recess 34 would be formed to frictionally engage the bridge member to hold it in position. This would work well where the lenses of the sub-frames are sunglasses and the surrounding of the user are dark or getting dark. This would also work well if the main frame 12 has a second pair of lenses engaged therein recessed behind the first frame 14 surface so as to work in combination with the lenses in the sub-frames.

In yet another mode of the device 10 and system in FIG. 7, as noted above, the main frame 12 of the device 10 may have pre-engaged lenses 42 within the viewing apertures 16. Additionally, the circumferential surface 22 may be configured with the circumferential recess 24 positioned in front of the pre-engaged lenses 42 which would be closer to the user's eyes when worn as shown. The recesses 24 thereby provide the snap in means for removably engagement of a supplemental pair of lenses 32 in front of, and in a registered position with existing lenses 42. For example, the first frame 14 of the main frame 12 may have prescription lenses 42 engaged thereon in positions closer to the wearer's face, and the sub-frames 26 would be positioned on the other side of the prescription lenses 42 and may have tinted or polarized lenses 32 engaged thereon.

In this mode, the sub-frames 26 can then be removably engaged within circumferential recess 24 in the viewing apertures 16 operatively positioned in front of the existing lenses 42 which are positioned closer to the wearer's face, to now provided polarized prescription eyewear. It is noted that other combinations of lenses may also be employed, for example prescription, sport, reading, polarized, circular polarized, tinted, and other lenses can be used in any combination thereof.

FIG. 8 shows a view of another particularly preferred mode of the device 10 providing means for removable engagement of a charm component 44 having a charm element 36 engaged thereon. It is commonly known in the art that sunglasses and other fashionable eyewear employing charm elements or designer logos and the like are placed in various locations of the eyewear frame, and in particular the upper corners of the first frame 14. As such the provision of removable engagement of the charm components 44 will allow the user to selectively accessorize their eyewear as desired with logos, team emblems, school mascots or logos and any number of personalized charm components 44.

In the current mode, means for removable engagement is provided through a slot 46 configured to slidably engaged or snap in a removable charm component 44. It is preferred that the slot 46 and component 44 have cross sections providing means for registered engagement, as shown in FIGS. 9a and 9b. However it is noted that other means for removable and registered engagement which one skilled in the art may also be employed, and are anticipated within this disclosure. It is additionally preferred that the charm component has at least one curved edge 45 which corresponds to the curvature of the circumferential surface 22 of the viewing apertures 16 such that the as used engaged position of the sub-frames 26 to the first frame 14 will provide a means for securing the charm component 44 in its engagement within the slot 46. However, in other mode the charm component 44 may simply snap fit into its engagement with the slot 46, employing snap fit means known in the art.

FIG. 10 and FIG. 11 show examples of pairs of charm components 44 having different charm elements 48, 50 which can be providable to the user in a kit as needed for accessorizing the device 10.

This invention has other applications, potentially, and one skilled in the art could discover these. The explication of the features of this invention does not limit the claims of this application; other applications developed by those skilled in the art will be included in this invention.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An interchangeable lens eyewear apparatus, comprising:
a first eyewear frame having temples and having a pair of lens apertures positioned on opposite sides of a bridge;
a sub-frame, said sub-frame having frame members surrounding respective lenses positioned on opposite sides of a bridge member engaged with said frame members; and
a snap-in connection positioned on said first eyewear frame, said snap-in connection configured to removably engage with said bridge member to operative positioning one each of said lenses in front of a respective said lens aperture of said first eyewear frame.

2. The interchangeable lens eyewear apparatus of claim 1 wherein said snap-in connection comprises:
a recess formed in each of said lens apertures of said first eyewear frame; and
each said recess sized to surround a respective said frame member of said sub-frame in a frictional engagement thereof.

3. The interchangeable lens eyewear apparatus of claim 1 wherein said snap-in connection comprises:
a slot positioned on said bridge of said first eyewear frame;
said slot having an opening sized slightly smaller than a diameter of said bridge member of said sub-frame; and
said slot formed into flexible material whereby said opening expands to allow positioning of said bridge member into said slot and removal therefrom.

4. The interchangeable lens eyewear apparatus of claim 3 additionally comprising:
said slot sized for a compressive rotational engagement of said bridge member therein; and
said sub-frame rotatable to position said lenses between a vertical positioning and directly in front of respective said lens apertures, and a horizontal positioning extending above a top edge of said lens apertures.

5. The interchangeable lens eyewear apparatus of claim 1 additionally comprising:
respective primary lenses positioned within said lens apertures of said pair of lens apertures of said first eyewear frame.

6. The interchangeable lens eyewear apparatus of claim 2 additionally comprising:
respective primary lenses positioned within said lens apertures of said pair of lens apertures of said first eyewear frame.

7. The interchangeable lens eyewear apparatus of claim 3 additionally comprising:
respective primary lenses positioned within said lens apertures of said pair of lens apertures of said first eyewear frame.

8. The interchangeable lens eyewear apparatus of claim 4 additionally comprising:
respective primary lenses positioned within said lens apertures of said pair of lens apertures of said first eyewear frame.

9. The interchangeable lens eyewear apparatus of claim 3 wherein said snap-in connection comprises:
said slot formed on a first side of a body of said flexible material;
adhesive positioned on a second side of said body opposite said first side; and
said slot positionable on said bridge through an engagement of said second side to said bridge to thereby position said slot upon aid bridge.

10. The interchangeable lens eyewear apparatus of claim 4 wherein said snap-in connection comprises:
said slot formed on a first side of a body of said flexible material;
adhesive positioned on a second side of said body opposite said first side; and
said slot positionable on said bridge through an engagement of said second side to said bridge to thereby position said slot upon aid bridge.

11. The interchangeable lens eyewear apparatus of claim 7 wherein said snap-in connection comprises:
said slot formed on a first side of a body of said flexible material;
adhesive positioned on a second side of said body opposite said first side; and
said slot positionable on said bridge through an engagement of said second side to said bridge to thereby position said slot upon aid bridge.

12. The interchangeable lens eyewear apparatus of claim 1 wherein said snap-in connection comprises:
said sub-frame being from a kit of a plurality of said sub-frames; and
each of said plurality having a different type of respective said lenses positioned therein, whereby a user can choose any one of said plurality of sub-frames from said plurality to engage with said first eyewear frame and thereby change the lenses viewed through said lens apertures.

13. The interchangeable lens eyewear apparatus of claim 2 wherein said snap-in connection comprises:
said sub-frame being from a kit of a plurality of said sub-frames; and
each of said plurality having a different type of respective said lenses positioned therein, whereby a user can choose any one of said plurality of sub-frames from said plurality to engage with said first eyewear frame and thereby change the lenses viewed through said lens apertures.

14. The interchangeable lens eyewear apparatus of claim 3 wherein said snap-in connection comprises:
said sub-frame being from a kit of a plurality of said sub-frames; and
each of said plurality having a different type of respective said lenses positioned therein, whereby a user can choose any one of said plurality of sub-frames from said plurality to engage with said first eyewear frame and thereby change the lenses viewed through said lens apertures.

15. The interchangeable lens eyewear apparatus of claim 5 wherein said snap-in connection comprises:
said sub-frame being from a kit of a plurality of said sub-frames; and
each of said plurality having a different type of respective said lenses positioned therein, whereby a user can choose any one of said plurality of sub-frames from said plurality to engage with said first eyewear frame and thereby change the lenses viewed through said lens apertures.

16. The interchangeable lens eyewear apparatus of claim 6 wherein said snap-in connection comprises:
said sub-frame being from a kit of a plurality of said sub-frames; and
each of said plurality having a different type of respective said lenses positioned therein, whereby a user can choose any one of said plurality of sub-frames from said plurality to engage with said first eyewear frame and thereby change the lenses viewed through said lens apertures.

17. The interchangeable lens eyewear apparatus of claim 7 wherein said snap-in connection comprises:
said sub-frame being from a kit of a plurality of said sub-frames; and
each of said plurality having a different type of respective said lenses positioned therein, whereby a user can choose any one of said plurality of sub-frames from said plurality to engage with said first eyewear frame and thereby change the lenses viewed through said lens apertures.

18. The interchangeable lens eyewear apparatus of claim 8 wherein said snap-in connection comprises:
said sub-frame being from a kit of a plurality of said sub-frames; and
each of said plurality having a different type of respective said lenses positioned therein, whereby a user can choose any one of said plurality of sub-frames from said plurality to engage with said first eyewear frame and thereby change the lenses viewed through said lens apertures.

19. The interchangeable lens eyewear apparatus of claim 9 wherein said snap-in connection comprises:
said sub-frame being from a kit of a plurality of said sub-frames; and
each of said plurality having a different type of respective said lenses positioned therein, whereby a user can choose any one of said plurality of sub-frames from said plurality to engage with said first eyewear frame and thereby change the lenses viewed through said lens apertures.

20. The interchangeable lens eyewear apparatus of claim 10 wherein said snap-in connection comprises:
said sub-frame being from a kit of a plurality of said sub-frames; and
each of said plurality having a different type of respective said lenses positioned therein, whereby a user can choose any one of said plurality of sub-frames from said plurality to engage with said first eyewear frame and thereby change the lenses viewed through said lens apertures.
